(19) United States
(12) Patent Application Publication
(10) Pub. No.: US 2026/0238897 A1
(43) Pub. Date: Aug. 13, 2026

(54) IMAGING DEVICE

(71) Applicant: SONY SEMICONDUCTOR SOLUTIONS CORPORATION, KANAGAWA (JP)

(72) Inventors: LUONGHUNG ASAKURA, KANAGAWA (JP); TSUBASA SAKAKI, KANAGAWA (JP); RUI MORIMOTO, KANAGAWA (JP); TAKAHIRO UCHIMURA, KANAGAWA (JP); YOUJI SAKIOKA, KANAGAWA (JP)

(21) Appl. No.: 19/471,507

(22) PCT Filed: Apr. 24, 2024
(86) PCT No.: PCT/JP2024/016075

§ 371 Date: Oct. 1, 2025

(30) Foreign Application Priority Data
Apr. 24, 2023 (JP) 2023-071114
Mar. 6, 2024 (WO) PCT/JP2024/008479

(51) Int. Cl. H04N 25/766; H04N 25/77

(52) U.S. Cl. CPC H04N 25/766; H04N 25/77

(57) ABSTRACT

Provided is an imaging device with low current consumption. An imaging device according to the present embodiment includes: a pixel section that photoelectrically converts incident light to generate a pixel signal, the pixel section including a plurality of pixels; a first signal line that transmits the pixel signal from the pixel unit; a second signal line that transmits a control signal for causing a current to flow through the first signal line; a capacitive element connected between the first signal line and the second signal line; a first switching element connected between the second signal line and a first power supply; and a second switching element and a current source connected in series between the second signal line and a second power supply.

### TECHNICAL FIELD

The present disclosure relates to an imaging device.

### BACKGROUND ART

An imaging device such as a complementary metal oxide semiconductor (CMOS) image sensor includes a pixel region and a peripheral circuit. In the imaging region, a plurality of pixels including a photodiode and a pixel circuit is arranged, and a pixel signal photoelectrically converted in the photodiode is output. The peripheral circuit includes a CMOS transistor or the like, and processes a pixel signal output from the imaging region.

A current source or a capacitor is connected to a signal line that transmits a pixel signal, and a current flows through the signal line when analogue to digital (AD) conversion is performed on the pixel signal.

### CITATION LIST

### Patent Document

Patent Document 1: Japanese Patent No. 4967489
Patent Document 2: WO 2022/200348 A

### SUMMARY OF THE INVENTION

### Problems to be Solved by the Invention

In a conventional imaging device, a relatively large current is required for charging/discharging and settling of a signal line. It is desired to reduce such current consumption as much as possible.

Therefore, the present disclosure provides an imaging device with low current consumption.

### Solutions to Problems

An imaging device according to one aspect of the present disclosure includes: a pixel section that photoelectrically converts incident light to generate a pixel signal, the pixel section including a plurality of pixels; a first signal line that transmits the pixel signal from the pixel unit; a second signal line that transmits a control signal for causing a current to flow through the first signal line; a capacitive element connected between the first signal line and the second signal line; a first switching element connected between the second signal line and a first power supply; and a second switching element and a current source connected in series between the second signal line and a second power supply.

The imaging device further includes a third switching element connected between the second signal line and the second power supply.

A plurality of the first signal lines is provided, and the capacitive element, the first switching element, the second switching element, and the current source are provided in each of the first signal lines.

The plurality of pixels constitutes a plurality of pixel columns, the plurality of first signal lines is provided corresponding to the plurality of pixel columns, respectively, and the second signal line is provided in common for the plurality of pixel columns.

The second signal line is provided in common with the plurality of first signal lines.

When the second switching element is in a conductive state, the current source causes a current to flow from the capacitive element to change a voltage of the control signal with a first slope.

After a voltage of the first signal line is set to a voltage corresponding to the pixel signal, the current source changes the voltage of the control signal with the first slope.

When the first switching element is in a conductive state, the first power supply charges the second signal line and the capacitive element.

When one of the first and second switching elements is in a conductive state, another of the first and second switching elements is in a non-conductive state.

The third switching element is a P-type metal oxide Semiconductor field effect transistor (MOSFET).

A first gate voltage is applied to a gate of the third switching element when the pixel signal generated in the pixel in a reset state is output to the first signal line, a second gate voltage is applied to a gate of the third switching element when the pixel signal generated in the pixel in a state of receiving incident light is output to the first signal line, and the first gate voltage is higher than the second gate voltage.

The plurality of pixels is connected between a third power supply and a fourth power supply, the third power supply having a voltage lower than a voltage of the first power supply, the fourth power supply having a voltage lower than a voltage of the second power supply.

A voltage difference between the third power supply and the fourth power supply is substantially equal to a voltage difference between the first power supply and the second power supply.

The imaging device further includes: a reference signal generator that generates a reference signal changing at a second slope; a comparator that compares the pixel signal from the first signal line with the reference signal; and a counter that is connected to an output of the comparator and performs counting from change start of the reference signal until the pixel signal and the reference signal intersect, in which the reference signal generator changes a voltage of the reference signal with the second slope in a direction opposite to a change in a voltage of the pixel signal with respect to a change in intensity of the incident light.

In a case where the voltage of the pixel signal decreases as the intensity of the incident light becomes larger, the reference signal generator changes the voltage of the reference signal with the second slope from a voltage lower than the voltage of the pixel signal to a voltage higher than the voltage of the pixel signal.

A fourth switching element connected between the first signal line and the second signal line is further included.

The fourth switching element is in a conductive state immediately before the third switching element is in a conductive state.

A second capacitive element having one end connected to a first node and another end connected to the second power supply, a fifth switching element connected between the first node and the current source, a sixth switching element connected between the first node and the first signal line, and a seventh switching element connected between the first node and the second signal line are further included.

At least one of the fifth to seventh switching elements is brought into a conductive state in a pre-charge operation before detection of the pixel signal.

### BRIEF DESCRIPTION OF DRAWINGS

FIG. 1 is a block diagram illustrating a configuration example of an imaging device including an imaging element and a signal processing section according to a first embodiment.

FIG. 2 is a diagram illustrating a configuration example of a certain column of the imaging element.

FIG. 3 is a diagram illustrating a configuration example of a ramp generator according to the first embodiment.

FIG. 4 is a timing diagram illustrating an operation example of a pixel and the ramp generator according to the first embodiment.

FIG. 5A is a diagram illustrating a configuration example of a switching element SW3 according to a second embodiment.

FIG. 5B is a timing diagram illustrating an operation example of a pixel and a ramp generator according to the second embodiment.

FIG. 6 is a diagram illustrating a configuration example of a pixel, a ramp generator, a sample-and-hold circuit, and a buffer circuit according to a third embodiment.

FIG. 7 is a diagram illustrating a range of voltage levels of nodes of a floating diffusion, a data signal line, an output of a sample-and-hold circuit, and an output of a buffer circuit according to the third embodiment.

FIG. 8 is a block diagram illustrating a configuration example of a pixel, a ramp generator, a comparator, a DAC, and a counter according to a fourth embodiment.

FIG. 9 is a timing diagram illustrating an operation example of the pixel, the ramp generator, the comparator, the DAC, and the counter according to the fourth embodiment.

FIG. 10 is a diagram illustrating a configuration example of a ramp generator according to a fifth embodiment.

FIG. 11 is a timing diagram illustrating an operation example of a pixel and the ramp generator according to the fifth embodiment.

FIG. 12 is a diagram illustrating a configuration example of a ramp generator according to a sixth embodiment.

FIG. 13 is a timing diagram illustrating an operation example of the ramp generator according to the sixth embodiment. FIG. 14 is a diagram illustrating a modification of the second to fourth embodiments.

FIG. 15 is a block diagram illustrating an example of a schematic configuration of a vehicle control system.

FIG. 16 is an explanatory diagram illustrating an example of installation positions of an outside-vehicle information detecting section and an imaging section.

### MODE FOR CARRYING OUT THE INVENTION

Hereinafter, specific embodiments to which the present technology is applied will be described in detail with reference to the drawings. The drawings are schematic or conceptual, and the ratio of each part and the like are not necessarily the same as actual ones. In the specification and the drawings, similar elements to those described above concerning the previously described drawings are denoted by the same reference signs, and detailed descriptions thereof are appropriately omitted.

### First Embodiment

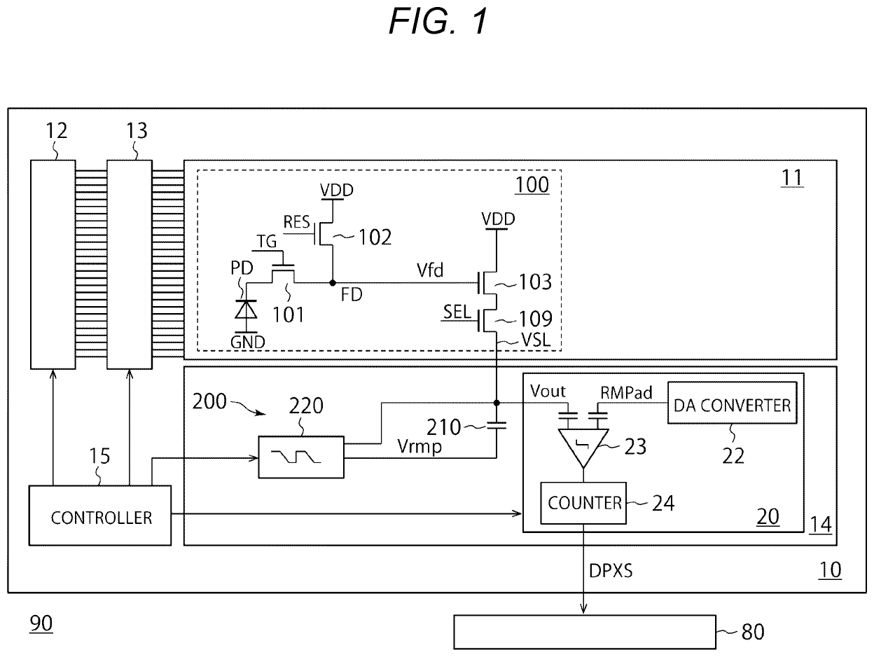

FIG. 1 is a block diagram illustrating a configuration example of an imaging device 90 including an imaging element 10 and a signal processing section 80 according to a first embodiment. The imaging element 10 includes a pixel array 11, a row decoder 12, a pixel driver 13, a column signal processing section 14, and a controller 15.

The pixel array 11 is configured by two-dimensionally arranging a plurality of pixels 100 in the row direction and the column direction. FIG. 1 illustrates one pixel 100.

The plurality of pixels 100 arranged in the column direction of the pixel array 11 is commonly connected to the same data signal line VSL, and constitute a pixel column. The plurality of pixels 100 included in one pixel column is sequentially selected by a selection signal SEL, and the pixel signals are sequentially output to the data signal line VSL.

The plurality of pixels 100 arranged in the row direction of the pixel array 11 is connected to different data signal lines VSL, and constitute a pixel row. The plurality of pixels 100 included in one pixel row is connected to different data signal lines VSL, and the pixel signals are simultaneously output to the corresponding data signal lines VSL.

The row decoder 12 and the pixel driver 13 drive the plurality of pixels 100 for each pixel row. For example, the row decoder 12 supplies a selection signal for selecting the plurality of pixels 100 arranged in the row direction to the pixel driver 13 according to an address signal from the controller 15. The pixel driver 13 drives transistors 101 to 103, and 109 of the plurality of pixels 100 in the pixel row according to a timing signal from the controller 15 and a selection signal from the row decoder 12. The row decoder 12 and the pixel driver 13 can output the pixel signals from all the pixels 100 of the pixel array 11 to the data signal lines VS without overlapping the pixel signals by sequentially driving the pixel rows in the direction of the pixel column.

The data signal line VSL as a first signal line transmits an output voltage Vout corresponding to the pixel signal of the pixel 100 to the column signal processing section 14. Hereinafter, the output voltage Vout corresponding to the pixel signal is also referred to as a pixel signal Vout.

The column signal processing section 14 is provided corresponding to the pixel column of the pixel 100, that is, for each data signal line VSL. The column signal processing section 14 includes an analogue-to-digital converter (ADC) 20. The ADC 20 digitally converts the pixel signal Vout received from the data signal line VSL to be output to the signal processing section 80. The ADC 20 includes a comparator 23, a digital-to-analogue converter (DAC) 22, and a counter 24. The number of the ADCs 20 may be larger or smaller than the number of the data signal lines VSL. In a case where the number of the ADCs 20 is smaller than the number of data signal lines VSL, the ADC 20 is shared by a plurality of data signal lines VSL and the plurality of data signal lines VSL are multiplexed.

The controller 15 controls components of the imaging element 10. The controller 15 generates an address and sends the address to the row decoder 12, or generates a timing signal and sends the timing signal to the pixel driver 13. The controller 15 controls the ADC 20 to perform AD conversion on the pixel signal Vout. Furthermore, the controller 15 also controls a ramp generator 220 to generate a ramp signal Vrmp.

The pixel 100 includes a photodiode (photoelectric conversion element) PD, a transfer transistor 101, a reset transistor 102, an amplification transistor 103, and a selection transistor 109. The transfer transistor 101, the reset transistor 102, the amplification transistor 103, and the selection transistor 109 include, for example, an n-type MOS field effect transistor (MOSFET). The transfer transistor 101, the reset transistor 102, the amplification transistor 103, and the selection transistor 109 control an electric signal output from the photodiode PD, and output the electric signal as a pixel signal to the data signal line VSL.

The photodiode PD photoelectrically converts incident light and generates an electric signal corresponding to the intensity of the incident light. The amount of charges generated in the photodiode PD corresponds to the intensity of the incident light. The incident light may include visible light, infrared light and/or ultraviolet light.

The transfer transistor 101 is connected between the photodiode PD and a floating diffusion FD. The transfer transistor 101 transfers the charge from the photodiode PD to the floating diffusion FD. The floating diffusion FD temporarily accumulates the charge. A transfer signal TG is supplied to the gate of the transfer transistor 101, and the transfer transistor 101 is controlled by the transfer signal TG.

The reset transistor 102 is connected between the floating diffusion FD and a power supply line to which a power supply voltage VDD is supplied. A reset signal RES is supplied to the gate of the reset transistor 102. As a result, the reset transistor 102 resets a potential Vfd of the floating diffusion FD to the power supply voltage VDD.

The floating diffusion FD is connected to the gate of the amplification transistor 103. The floating diffusion FD functions as an input node of the amplification transistor 103. The floating diffusion FD temporarily holds the charges accumulated in the photodiode PD.

The amplification transistor 103 and the selection transistor 109 are connected in series between the power supply line of the power supply voltage VDD and the data signal line VSL. As a result, the amplification transistor 103 is connected to the data signal line VSL via the selection transistor 109.

The selection signal SEL is supplied to the gate of the selection transistor 109. When the selection transistor 109 is brought into a conductive state, the amplification transistor 103 amplifies the potential Vfd of the floating diffusion FD, and outputs a voltage corresponding to the potential Vfd to the data signal line VSL as the pixel signal Vout. The data signal line VSL transmits the pixel signal Vout from the pixel 100 to the column signal processing section 14.

The gates of the transfer transistor 101, the reset transistor 102, and the selection transistor 109 are commonly connected to the pixel driver 13 for each pixel row. Therefore, the pixel driver 13 can simultaneously drive the plurality of pixels 100 included in one pixel row.

The data signal line VSL is connected to a constant current circuit 200 including a capacitive element 210 and the ramp generator 220. The constant current circuit 200 is configured as a capacitor current source that at least temporarily supplies a constant current to the data signal line VSL. A more detailed configuration of the capacitive element 210 and the constant current circuit 200 will be described later.

During a period in which the constant current circuit 200 causes a constant current to flow through the data signal line VSL, the amplification transistor 103 transmits the pixel signal Vout corresponding to the potential Vfd of the floating diffusion FD to the data signal line VSL. The ADC 20 converts the received pixel signal Vout into digital pixel data DPXS and outputs the digital pixel data DPXS to the signal processing section 80.

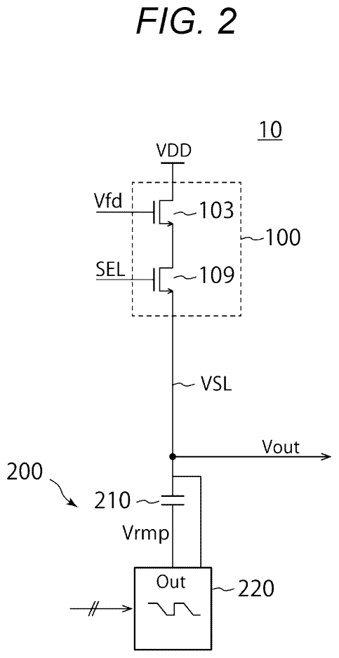

FIG. 2 is a diagram illustrating a configuration example of a certain column of the imaging element 10. The imaging element 10 generates a pixel signal Vout having a voltage corresponding to the intensity of the incident light. During the selection period in which the signal SEL is activated to high level, the pixel 100 outputs the pixel signal Vout to the data signal line VSL.

The capacitive element 210 is connected between the data signal line VSL and the ramp generator 220. For example, one first electrode of the capacitive element 210 is connected to the data signal line VSL and the ramp generator 220. The other second electrode of the capacitive element 210 is connected to the ramp generator 220. Note that the ramp generator 220 and the capacitive element 210 may be directly connected. Alternatively, an element or a circuit that allows signal transmission, such as, for example, an FET, a switch, and/or a resistive element, may be interposed between the ramp generator 220 and the capacitive element 210.

The capacitive element 210 is charged by the power supply voltage VDD in the reset operation before the selection period. The capacitive element 210 receives the ramp signal Vrmp from the ramp generator 220 during the selection period, and causes a constant current to flow through the data signal line VSL according to a change in the voltage of the ramp signal Vrmp. As a result, the amplification transistor 103 functions as a source follower, and outputs the pixel signal Vout having a voltage corresponding to the potential Vfd of the floating diffusion FD to the data signal line VSL.

The ramp generator 220 generates the ramp signal Vrmp as a control signal according to a signal received from the controller 15 during the selection period, and outputs the ramp signal Vrmp to the second electrode of the capacitive element 210.

The ramp generator 220 linearly changes the voltage of the ramp signal Vrmp at a first slope. As a result, the ramp signal Vrmp that linearly changes with the first slope is input to the second electrode of the capacitive element 210, and a constant current flows from the first electrode of the capacitive element 210 to the data signal line VSL. As a result, the amplification transistor 103 functions as a source follower, and a pixel signal Vout having a voltage corresponding to the potential Vfd of the floating diffusion FD is generated in the data signal line VSL.

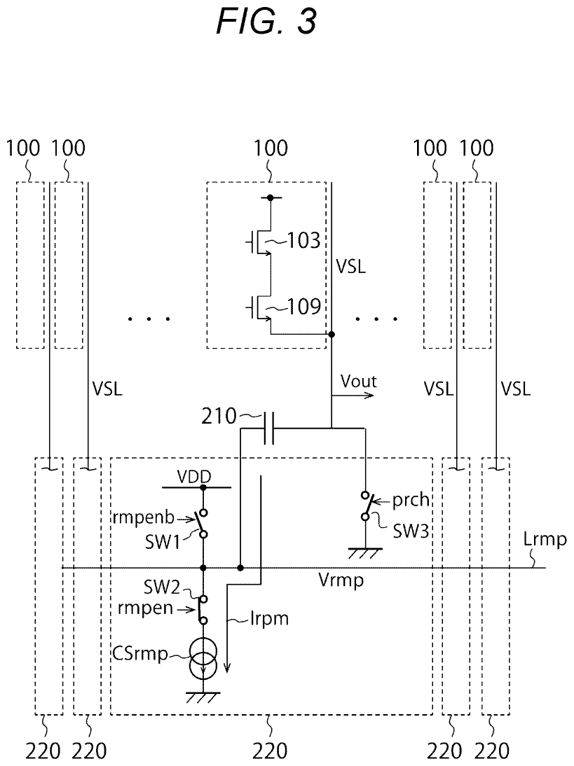

FIG. 3 is a diagram illustrating a configuration example of the ramp generator 220 according to the first embodiment. The ramp generator 220 includes a ramp signal line Lrmp, switching elements SW1 to SW3, and a current source CSrmp.

The ramp signal line Lrmp as a second signal line transmits the ramp signal Vrmp that causes a current to flow through the data signal line VSL. The ramp signal line Lrmp may be provided for each pixel column corresponding to a respective one of the data signal lines VSL. However, one ramp signal line Lrmp may be provided in common to a plurality of the data signal lines VSL (that is, for a plurality of the pixel columns). By sharing one ramp signal line Lrmp by the plurality of data signal lines VSL, constant currents Irmp of the plurality of pixel columns are averaged, and the variation and noise can be suppressed. By suppressing the variation and noise of the constant current Irmp, it is possible to suppress the variation and noise of the ramp signal Vrmp and the pixel signal Vout.

The switching element SW1 as a first switching element is connected between the power supply of the power supply voltage VDD and the ramp signal line Lrmp. The switching element SW1 is controlled to be either on (conductive state) or off (non-conductive state) by an inverted signal rmpenb of a signal rmpen. The switching element SW2 as a second switching element is connected between the current source CSrmp and the ramp signal line Lrmp. The switching element SW2 is controlled to be either on (conductive state) or off (non-conductive state) by the signal rmpen.

The switching elements SW1 and SW2 are controlled by the signals rmpenb and rmpen of opposite logic to each other. Therefore, when one of the switching elements SW1 and SW2 is turned on, the other of the switching elements SW1 and SW2 is turned off. The switching elements SW1 and SW2 may be MOSFETs. The switching elements SW1 and SW2 include n-type MOSFETs, for example.

The switching element SW3 is connected between the data signal line VSL (the first electrode of the capacitive element 210) and a ground GND. The switching element SW3 is controlled to be turned on or off by a signal prch. When the switching element SW3 is turned on, the data signal line VSL (the first electrode of the capacitive element 210) is pre-charged to a reference voltage of the ground GND (ground voltage).

The current source CSrmp is connected between the switching element SW2 and the ground GND. That is, the switching element SW2 and the current source CSrmp are connected in series between the ramp signal line Lrmp and the ground GND. When the switching element SW2 is turned on, the current source CSrmp causes the constant current Irmp to flow from the ramp signal line Lrmp and the second electrode of the capacitive element 210. As a result, the current source CSrmp linearly changes the voltage of the ramp signal Vrmp with the first slope, and temporarily causes a constant current to flow through the data signal line VSL via the capacitive element 210. By causing a constant current to flow through the data signal line VSL, the pixel signal Vout is set to a voltage in a reset state of the pixel 100 (hereinafter, also referred to as a reset signal) or a voltage corresponding to the potential Vfd of the floating diffusion FD (hereinafter, also referred to as a data signal). The operation of setting the pixel signal Vout of the data signal line VSL to the voltage of the reset signal or the data signal as described above is hereinafter also referred to as “settling”. The current source CSrmp includes, for example, an n-type MOSFET.

The capacitive element 210, the switching elements SW1 and SW2, and the current source CSrmp are provided corresponding to each of the data signal lines VSL of the plurality of pixel columns. Therefore, in each pixel column, the pixel signal Vout can be set to the reset signal or the data signal.

The switching elements SW1 to SW3 and the current source CSrmp are controlled by the signals rmpenb, rmpen, and prch received from the controller 15.

Next, the operations of the pixel 100 and the ramp generator 220 according to the present embodiment will be described.

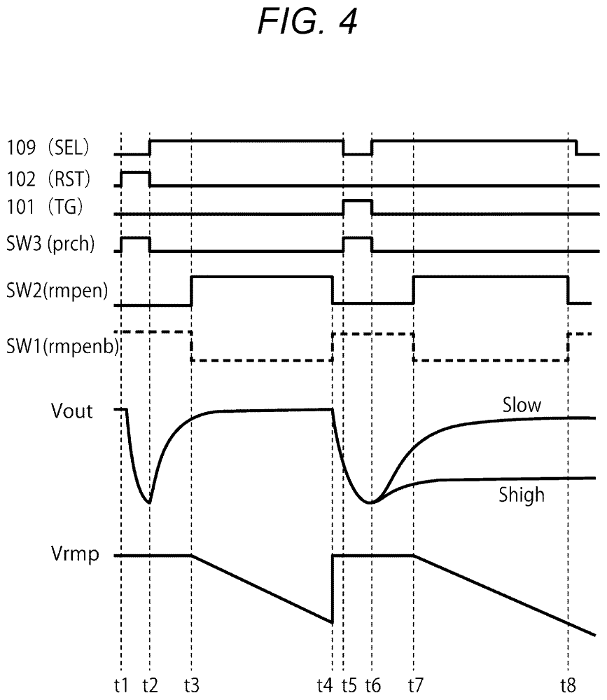

FIG. 4 is a timing diagram illustrating an operation example of the pixel 100 and the ramp generator 220 according to the first embodiment.

First, before time point t1, the selection transistor 109 is turned off, and the pixel 100 is electrically separated from the data signal line VSL.

At the time point t1, the controller 15 activates a signal RST to turn on the reset transistor 102, and activates the signal prch to turn on the switching element SW3. As a result, the reset transistor 102 charges the floating diffusion FD with the power supply voltage VDD. Furthermore, the switching element SW3 pre-charges the voltage of the data signal line VSL (the first electrode of capacitive element 210) to the reference voltage (for example, the ground voltage). As a result, in t1 to t2, the pixel signal Vout is pre-charged from the power supply voltage VDD of high level to the reference voltage, for example.

At this time, the signal rmpenb is activated to the high level, and the switching element SW1 is turned on. On the other hand, the signal rmpen is inactivated to low level, and the switching element SW2 is turned off. Therefore, the ramp signal line Lrmp (the second electrode of the capacitive element 210) is pre-charged by the power supply voltage VDD. The ramp signal Vrmp is set to, for example, the power supply voltage VDD of high level. As a result, the capacitive element 210 is pre-charged between the reference voltage (for example, the ground voltage) and the power supply voltage VDD.

At time point t2, the controller 15 inactivates the signal RST and the signal prch, and turns off the reset transistor 102 and the switching element SW3. As a result, the floating diffusion FD is electrically separated from the power supply voltage VDD. Furthermore, the data signal line VSL (the first electrode of the capacitive element 210) is electrically separated from the reference voltage source (for example, ground), and the pre-charge ends.

The controller 15 activates the signal SEL to turn on the selection transistor 109. At this time, the signal TG remains in the inactive state with the low level, and the transfer transistor 101 is turned off. Therefore, the potential Vfd of the floating diffusion FD is maintained at a high-level voltage (VDD) and is in a reset state. As a result, in t2 to t3, the pixel 100 outputs the pixel signal (reset signal) in the reset state (dark state) to the data signal line VSL.

For example, at t2, the pixel signal Vout is pre-charged to the reference voltage (for example, the ground voltage), and approaches the reset signal (for example, a high-level voltage) in t2 to t3.

At t3, the controller 15 activates the signal rmpen to the high level to turn on the switching element SW2 and turn off the switching element SW1. As a result, the current source CSrmp causes the constant current Irmp to flow from the capacitive element 210 and the ramp signal line Lrmp, and extracts the charge pre-charged in the capacitive element 210 and the ramp signal line Lrmp. As a result, the ramp signal Vrmp linearly changes at the first slope.

In t3 to t4, the ramp signal Vrmp linearly decreases, so that a constant current flows through the data signal line VSL. As a result, the pixel signal Vout is set (settled) to the voltage level of the reset signal.

Although not illustrated in FIG. 4, the ADC 20 in FIG. 1 performs AD conversion on the pixel signal Vout in a period in which the pixel signal Vout is settled to the voltage level of the reset signal. For example, after the settling, the DAC 22 starts the operation of an AD ramp signal RMPad. The comparator 23 compares the AD ramp signal RMPad received from the DAC 22 with the pixel signal Vout, and inverts the logic of the output signal when the AD ramp signal RMPad intersects with the pixel signal Vout. The counter 24 counts clock pulses from the start of the operation of the AD ramp signal RMPad to the inversion of the output signal of the comparator 23. As a result, the ADC 20 can perform AD conversion on the voltage level of the reset signal to be output as digital pixel data DPXS to the signal processing section 80.

After the AD conversion of the reset signal, at t4, the controller 15 inactivates the signal rmpen to the low level to turn off the switching element SW2 and turn on the switching element SW1. As a result, the ramp signal line Lrmp is connected to the power supply line of the power supply voltage VDD, and is electrically separated from the current source CSrmp. The ramp signal line Lrmp and the capacitive element 210 are charged again at the power supply voltage VDD of high level.

In t5 to t8, the operations of the selection transistor 109 and the switching elements SW1 to SW3 may be the same as the operations of those in t1 to t4.

On the other hand, at t5, the controller 15 activates the signal TG to turn on the transfer transistor 101. As a result, the transfer transistor 101 transfers the charge generated in the photodiode PD to the floating diffusion FD. The potential Vfd is at a voltage level corresponding to the intensity of the incident light. Note that the reset transistor 102 is maintained in a non-conductive state.

The signal SEL is in an inactive state to low level, and the selection transistor 109 is in a non-conductive state. Therefore, the pixel signal Vout from the pixel 100 has not yet been transmitted to the data signal line VSL.

Other operations in t5 to t6 may be the same as the operations in t1 to t2.

At t6, the controller 15 activates the signal SEL to turn on the selection transistor 109. At this time, the potential Vfd of the floating diffusion FD is at a voltage level corresponding to the intensity of the incident light. As a result, the pixel 100 outputs a pixel signal (data signal) corresponding to the intensity of the incident light to the data signal line VSL in t6 to t8. For example, in a case where the intensity of the incident light is small, the pixel signal Vout increases to a relatively high-level voltage as indicated by a Slow. On the other hand, in a case where the intensity of the incident light is large, the pixel signal Vout increases only to a relatively constant level voltage as indicated by an Shigh.

In t7 to t8, the ramp signal Vrmp linearly decreases, so that a constant current flows through the data signal line VSL. As a result, the pixel signal Vout is settled to the voltage level of the data signal.

The ADC 20 performs AD conversion on the voltage level of the data signal to be output as digital pixel data DPXS to the signal processing section 80.

Other operations in t6 to t8 may be the same as the operations in t2 to t4.

The signal processing section 80 can calculate a digital value corresponding to the intensity of the incident light by subtracting the reset signal detected in t3 to t4 from the data signal detected in t7 to t8 using a correlated double sampling (CDS) method.

As described above, according to the present embodiment, the ramp generator 220 supplies the ramp signal Vrmp to the capacitive element 210 connected to the data signal line VSL, thereby allowing a constant current to flow from the capacitive element 210 to the data signal line VSL for a certain period of time. As a result, the current consumption can be reduced as compared with the case where the current source is directly connected to the data signal line VSL.

Note that, in the source follower circuit illustrated in FIG. 2, the operation in which the pixel signal Vout returns from the low potential to the high potential at the time of settling is faster than the operation in which the pixel signal Vout returns from the high potential to the low potential. Therefore, as indicated by t2 to t4 or t6 to t8 in FIG. 4, the amount of current flowing through the data signal line VSL can be reduced by returning the pixel signal Vout from the low potential to the high potential at the time of settling. Therefore, it can be said that the settling operation illustrated in t2 to t4 or t6 to t8 is suitable for a method of causing a constant current to flow through the data signal line VSL by the capacitive element 210 and the ramp generator 220 as in the present embodiment.

Furthermore, according to the present embodiment, the current source CSrmp causes the constant current Irmp to flow from the capacitive element 210 and the ramp generator 220 in a period in which the capacitive element 210 generates the ramp signal Vrmp. In this case, almost all the constant current Irmp flowing through the current source CSrmp is used for discharging (or charging) the capacitive element 210. Therefore, unnecessary current consumption is reduced, and power efficiency is improved.

Furthermore, according to the present embodiment, one ramp signal line Lrmp is provided in common for a plurality of the ramp generators 220 or the plurality of data signal lines VSL corresponding to the plurality of pixel columns. As a result, the constant currents Irmp in the plurality of pixel columns are averaged, whereby the variation and noise of the constant currents Irmp can be suppressed. By suppressing the variation and noise of the constant current Irmp, the variation and noise of the pixel signal Vout of the data signal line VSL in the plurality of pixel columns can also be suppressed.

### Second Embodiment

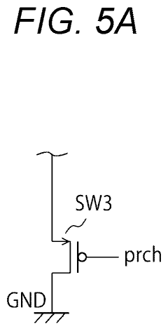

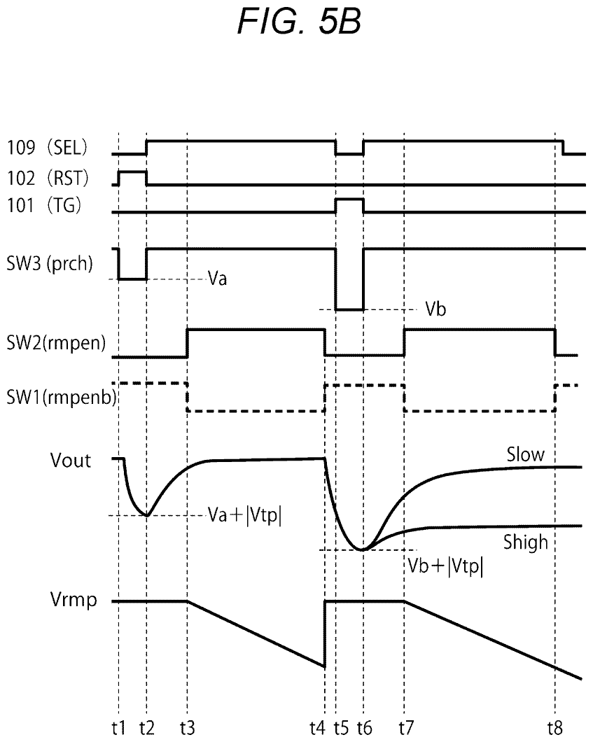

FIG. 5A is a diagram illustrating a configuration example of the switching element SW3 according to a second embodiment. FIG. 5B is a timing diagram illustrating an operation example of the pixel 100 and the ramp generator 220 according to the second embodiment. The configuration of the ramp generator 220 according to the second embodiment may be the same as the configuration illustrated in FIG. 3. However, the second embodiment is different from the first embodiment in that the switching element SW3 includes a p-type MOSFET as illustrated in FIG. 5A. The other configurations of the second embodiment may be similar to the configurations of the first embodiment.

In the second embodiment, the operations of the selection transistor 109, the reset transistor 102, and the transfer transistor 101 of the pixel 100 may be the same as the operations of those in the first embodiment. Furthermore, the operations of the switching elements SW1 and SW2 of the ramp generator 220 may be the same as the operations of those in the first embodiment.

On the other hand, as illustrated in FIG. 5B, the operation of the switching element SW3 in the second embodiment is different from the operation of the switching element SW3 in the first embodiment. Since the switching element SW3 is a p-type MOSFET, the switching element SW3 is turned off when the signal prch is at a high-level voltage and turned on when the signal prch is at a low-level voltage.

In the second embodiment, in the detection of the reset signal in t1 to t2, the signal prch is set to a first gate voltage Va. As a result, the pixel signal Vout of the data signal line VSL is substantially pre-charged to the voltage Va+|Vtp|. Note that Vtp is a threshold voltage of the switching element SW3.

Furthermore, in the detection of the data signals in t5 to t6, the signal prch is set to a second gate voltage Vb lower than the first gate voltage Va. As a result, the pixel signal Vout of the data signal line VSL is substantially pre-charged to the voltage Vb+|Vtp|. Since the first gate voltage Va is higher than the second gate voltage Vb, the voltage Va+|Vtp| is higher than the voltage Vb+|Vtp|. Therefore, the degree of pre-charge at t2 is weaker than the degree of pre-charge at t6.

In t3 to t4, the pixel signal Vout is settled to a high-level voltage for the detection of a reset signal. Therefore, the pre-charge voltage Va+|Vtp|at the time of detecting the reset signal at t2 does not need to be lowered to the pre-charge voltage Vb+|Vtp|(for example, the ground voltage) at the time of detecting the data signal at t6. Therefore, when the reset signal is output to the data signal line VSL, the first gate voltage Va is applied to the gate of the switching element SW3 as the signal prch.

On the other hand, in t7 to t8, the pixel signal Vout can be settled to various voltage values according to the intensity of the incident light for the detection of the data signal. Therefore, the pre-charge voltage Vb+|Vtp|at the time of detecting the data signal at t6 needs to be lowered to a voltage lower than the pre-charge voltage Va+|Vtp|at the time of detecting the reset signal. Therefore, when the data signal is output to the data signal line VSL, the second gate voltage Vb lower than the first gate voltage Va is applied to the gate of the switching element SW3 as the signal prch. As a result, the imaging device 90 can detect data signals of a wide range of voltage levels.

At the time of the detection of the reset signal in t2 to t4, the pixel signal Vout returns, to the settling voltage corresponding to the reset signal, from the pre-charge voltage Va+|Vtp), which is relatively higher (closer to the settling voltage) than the pre-charge voltage Vb+|Vtp|at the time of the detection of the data signal. Therefore, in the pre-charge of the data signal line VSL, unnecessary charge current and discharge current are suppressed. This reduces current consumption. Furthermore, the settling period of the pixel signal Vout of the data signal line VSL is shortened. As a result, the frame rate in imaging can be shortened.

### Third Embodiment

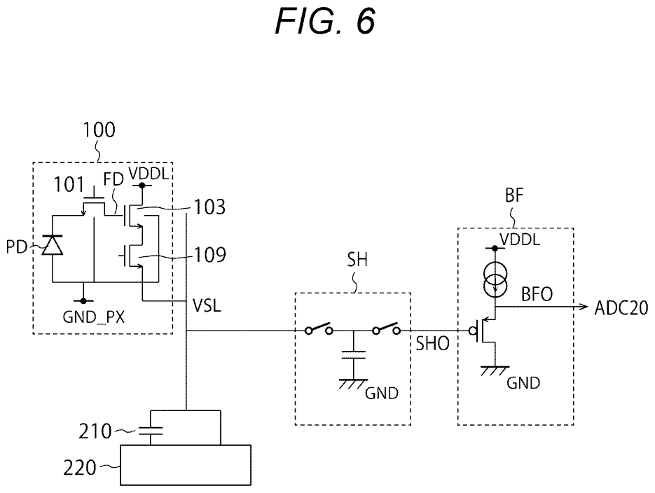

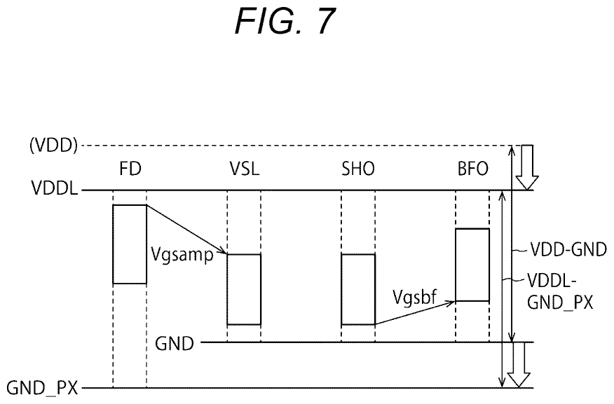

FIG. 6 is a diagram illustrating a configuration example of the pixel 100, the ramp generator 220, a sample-and-hold circuit SH, and a buffer circuit BF according to a third embodiment. FIG. 7 is a diagram illustrating a range of voltage levels of nodes of the floating diffusion FD, the data signal line VSL, an output SHO of the sample-and-hold circuit SH, and an output BFO of the buffer circuit BF according to the third embodiment. The configuration of the ramp generator 220 of the third embodiment may be the same as that of the first embodiment.

The pixel 100 is connected between the power supply line of a high-level voltage VDDL and the power supply line of a low-level voltage GND_PX, and is supplied with power between the high-level voltage VDDL and the low-level voltage GND_PX.

The low-level voltage GND_PX is a voltage lower than the ground voltage GND as a reference voltage used in the ramp generator 220, the sample-and-hold circuit SH, and the buffer circuit BF.

Furthermore, the high-level voltage VDDL is a voltage lower than the power supply voltage VDD by a voltage difference between the ground voltage GND and the low-level voltage GND_PX.

In a case where a constant current source (load transistor) is directly connected to the data signal line VSL to cause a constant current to flow, a voltage Vlm applied to the load transistor, a voltage Vir applied to the data signal line VSL, and a gate-source voltage Vgsamp of the amplification transistor 103 are generated in a constant current path. Accordingly, it is difficult to set the power supply voltage VDD low.

On the other hand, in a case where the constant current Irmp is generated by the capacitive element 210 and the ramp generator 220, since the current flows from the capacitive element 210, the component of the voltage Vlm applied to the load transistor is eliminated. Furthermore, the constant current Irmp generated by the capacitive element 210 and the ramp generator 220 has a current value smaller than that in a case where a current source is directly connected to the data signal line VSL to cause a current to flow. Since the constant current Irmp is small, the voltage Vir applied to the data signal line VSL and the gate-source voltage Vgsamp of the amplification transistor 103 are also small. Therefore, in a case where the constant current Irmp is generated by the capacitive element 210 and the ramp generator 220, the power supply voltage VDD can be lowered as compared with a case where a current source is directly connected to the data signal line VSL to generate a constant current.

However, for example, when the power supply voltage VDD is simply lowered to the high-level voltage VDDL, the power supply voltage applied to the pixel 100 also becomes the high-level voltage VDDL, and the voltage difference applied to the photodiode PD becomes small. For example, when the power supply voltage VDD is simply lowered to the high-level voltage VDDL, the voltage difference applied to the floating diffusion FD becomes VDDL-GND and becomes smaller than VDD-GND as illustrated in FIG. 7. In this case, the saturation charge amount of the photodiode PD decreases.

Therefore, in the pixel 100, as illustrated in FIG. 7, the power supply voltage VDD is lowered to the high-level voltage VDDL, and the reference voltage (for example, the ground voltage) is also shifted to the negative side by the voltage difference VDD−VDDL. That is, the reference voltage of the photodiode PD is set to, for example, the low-level voltage GND_PX lower by (VDD−VDDL) than the ground voltage GND of the ground GND. In this case, the low-level voltage GND_PX becomes GND−(VDD−VDDL). The voltage difference between the ground voltage GND and the low-level voltage GND_PX is substantially equal to the voltage difference between the power supply voltage VDD and the high-level voltage VDDL. That is, the voltage difference (VDDL−GND_PX) between the high-level voltage VDDL and the reference voltage GND_PX of the pixel 100 is equal to the voltage difference (VDD−GND) between the power supply voltage VDD and the reference voltage GND. As a result, the saturation charge amount of the photodiode PD can be maintained. Furthermore, design change of the photodiode PD and the transistors 101 to 103 and 109 constituting the pixel 100 becomes unnecessary.

As described above, in the third embodiment, the power supply voltages of the pixel 100, the ramp generator 220, the sample-and-hold circuit SH, and the buffer circuit BF are lowered from VDD to the high-level voltage VDDL. Furthermore, the reference voltage of the pixel 100 is lowered from GND to the low-level voltage GND_PX, and the reference voltages of the ramp generator 220, the sample-and-hold circuit SH, and the buffer circuit BF remain at the ground voltage GND. As a result, the power supply voltage of the pixel 100, the ramp generator 220, the sample-and-hold circuit SH, and the buffer circuit BF can be lowered to VDDL without changing the design of each component of the pixel 100.

### Fourth Embodiment

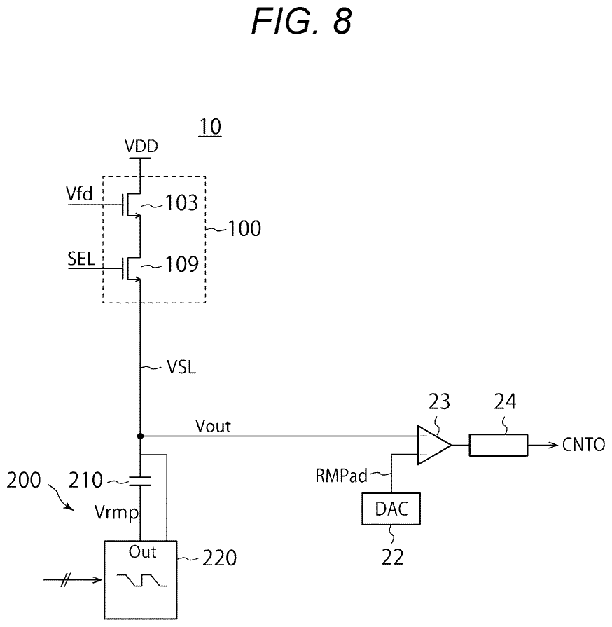

FIG. 8 is a block diagram illustrating a configuration example of the pixel 100, the ramp generator 220, the comparator 23, the DAC 22, and the counter 24 according to a fourth embodiment. The configurations of the pixel 100, the ramp generator 220, the comparator 23, the DAC 22, and the counter 24 may be the same as those of the first embodiment. The pixel 100, the ramp generator 220, the comparator 23, the DAC 22, and the counter 24 are controlled by the controller 15 in FIG. 1.

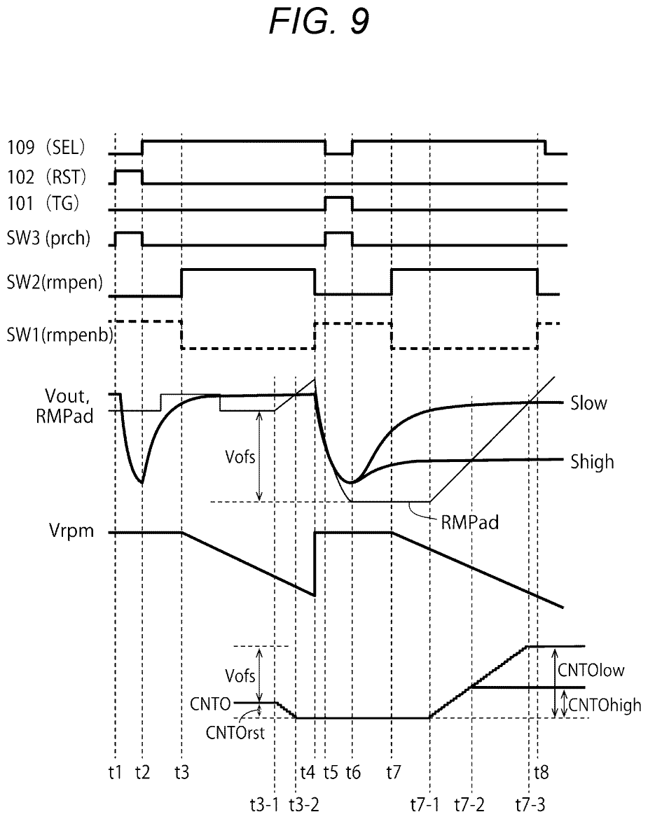

FIG. 9 is a timing diagram illustrating an operation example of the pixel 100, the ramp generator 220, the comparator 23, the DAC 22, and the counter 24 according to the fourth embodiment.

According to the fourth embodiment, the DAC 22 serving as a reference signal generator linearly changes the AD ramp signal RMPad serving as the reference signal with a second slope in the direction opposite to the direction of change in the voltage of the pixel signal Vout with respect to the change in the intensity of the incident light. That is, the DAC 22 linearly changes the AD ramp signal RMPad from a pixel signal Shigh side corresponding to the incident light with high intensity to a pixel signal Slow side corresponding to the incident light with low intensity. In other words, the DAC 22 linearly changes the AD ramp signal RMPad in the direction opposite to the direction of the settling of the pixel signal Vout.

Note that the AD ramp signal RMPad is a reference signal supplied from the DAC 22 to the comparator 23, compared with the pixel signal Vout in the comparator 23, and used for AD conversion of the pixel signal Vout. Therefore, the AD ramp signal RMPad is a signal different from the ramp signal Vrmp used for generating the constant current Irmp.

For example, at the time of detecting the reset signal in t3-1 to t3-2, the DAC 22 linearly changes the AD ramp signal RMPad from a voltage lower than the pixel signal Vout to a voltage higher than the pixel signal Vout. Furthermore, at the time of detecting the data signal in t7-1 to t7-3, the DAC 22 linearly changes the AD ramp signal RMPad from a voltage lower than the pixel signals Slow and Shigh to a voltage higher than the pixel signals Slow and Shigh.

The operations of the other signals of the fourth embodiment may be the same as the operations of the corresponding signals of the first embodiment.

The AD ramp signal RMPad differs by an offset voltage Vofs between the detection of the reset signal and the detection of the data signal at the ramp start time point (t3-1, t7-1). Therefore, when CDS processing is performed on a count value CNTO of the counter 24, the ADC 20 needs to perform calculation in consideration of the offset voltage Vofs.

For example, in t3-1 to t3-2, the counter 24 outputs a count value CNTOrst corresponding to the reset signal. In t7-1 to t7-2 or t7-3, the counter 24 outputs a count value CNTOd (CNTOhigh or CNTOlow) corresponding to the data signal. In this case, the ADC 20 calculates Equation 1 using a digital value of the pixel signal Vout as Dout and the voltage of the quantization unit (1lsb) as Vlsb. Dout=Vofs/Vlsb−(CNTOd−CNTOrst) (Equation 1)

In this manner, the ADC 20 can perform AD conversion of the pixel signal Vout into the digital value Dout.

The reason why the AD ramp signal RMPad is linearly changed in the direction opposite to the direction of the settling of the pixel signal Vout in this manner is as follows. In a case where the constant current Irmp is generated using the ramp signal line Lrmp and the capacitive element 21, the pixel signal Vout is settled from a low voltage to a high voltage after pre-charge. Therefore, in a case where the AD ramp signal RMPad linearly changes from a high voltage to a low voltage, the AD ramp signal RMPad quickly intersects with the pixel signal Slow having a relatively long settling time, and slowly intersects with the pixel signal Shigh having a relatively short settling time. In this case, the controller 15 needs to delay the start of the operation of the AD ramp signal RMPad in accordance with the settling time of the pixel signal Slow. This is because, if the AD ramp signal RMPad intersects with the pixel signal Slow before the pixel signal Slow is settled, a settling error occurs and an accurate count value CNTOlow cannot be obtained.

On the other hand, as in the fourth embodiment, in a case where the AD ramp signal RMPad linearly changes from a low voltage to a high voltage, the AD ramp signal RMPad quickly intersects the pixel signal Shigh having a relatively short settling time, and slowly intersects the pixel signal Slow having a relatively long settling time. In this case, the DAC 22 can advance the start of the operation of the AD ramp signal RMPad in accordance with the settling time of the pixel signal Shigh. Even if the operation of the AD ramp signal RMPad is started early, when the AD ramp signal RMPad intersects with the pixel signal Slow, the pixel signal Slow has been settled. Therefore, the operation of the AD ramp signal RMPad can be started early, and the frame rate can be shortened. Furthermore, a settling time of the pixel signal Slow can be secured. Therefore, according to the fourth embodiment, accurate count values CNTOhigh and CNTOlow can be obtained.

Furthermore, since the AD ramp signal RMPad intersects with the pixel signal Shigh relatively quickly, a settling error is likely to occur in the pixel signal Shigh. However, since the pixel signal Shigh corresponds to the incident light with high intensity, noise is also relatively large. Therefore, the settling error is buried in noise and is not very noticeable.

As described above, by linearly changing the AD ramp signal RMPad from a low voltage to a high voltage, a high-quality image can be captured at a high frame rate.

### Fifth Embodiment

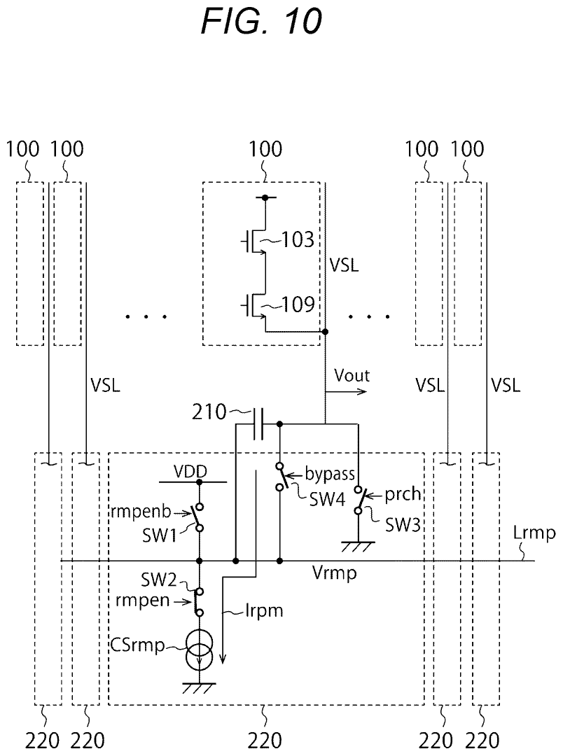

FIG. 10 is a diagram illustrating a configuration example of the ramp generator 220 according to a fifth embodiment. The ramp generator 220 further includes a switching element SW4. The other configurations of the fifth embodiment may be similar to the corresponding configurations of the first embodiment.

The switching element SW4 is connected between the data signal line VSL (the first electrode of the capacitive element 210) and the ramp signal line Lrmp. The switching element SW4 is controlled to be turned on or off by a signal bypass. The switching element SW4 is turned on immediately before the data signal line VSL is pre-charged (immediately before the switching element SW3 is turned on), and short-circuits the ramp signal line Lrmp and the data signal line VSL. As a result, the voltage of the ramp signal line Lrmp and the voltage of the data signal line VSL before the pre-charge are neutralized, and the data signal line VSL is pre-charged to some extent by the ramp signal line Lrmp. That is, in the fifth embodiment, the pre-charge of the data signal line VSL is performed by the internal pre-charge from the ramp signal line Lrmp and the external pre-charge via the switching element SW3. The switching elements SW4 includes an n-type MOSFET, for example. The signal bypass is controlled by the controller 15.

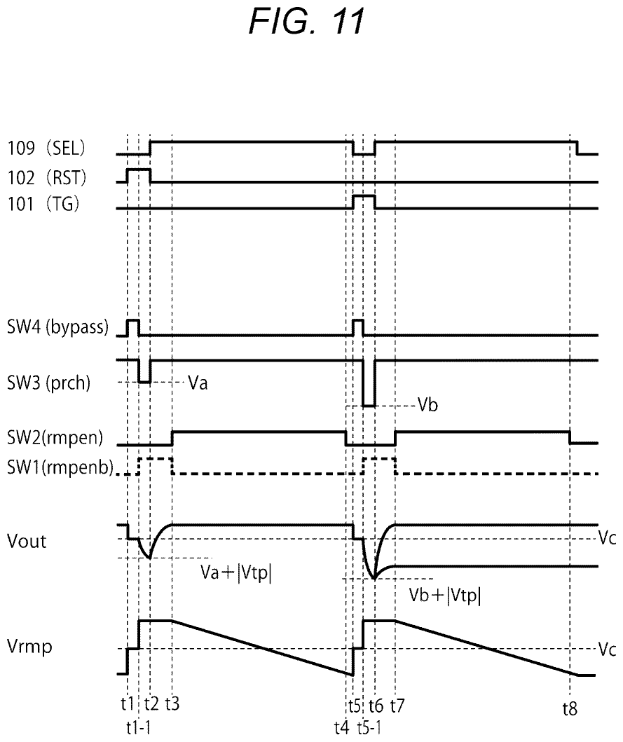

FIG. 11 is a timing diagram illustrating an operation example of the pixel 100 and the ramp generator 220 according to the fifth embodiment.

The operation of the fifth embodiment is different from the operation of the second embodiment in the operation of the pre-charge. For example, in the pre-charge operation in t1 to t2, first, the signal bypass is activated to turn on the switching element SW4 (t1 to t1-1). At this time, the data signal line VSL has a voltage corresponding to the pixel signal Vout. The ramp signal line Lrmp has decreased to near the reference voltage (for example, the ground voltage) in the previous detection of the pixel signal Vout. By the switching element SW4 short-circuiting the ramp signal line Lrmp and the data signal line VSL, the voltage of the ramp signal line Lrmp and the voltage of the data signal line VSL are neutralized to be the intermediate voltages thereof. That is, the data signal line VSL is internally pre-charged by the ramp signal line Lrmp.

Next, the signal bypass is inactivated to turn off the switching element SW4, and then the switching element SW3 is turned on to pre-charge the data signal line VSL to the reference voltage (for example, the ground voltage) (t1-1 to t2). The pre-charge operation in t1-1 to t2 may be the same as the pre-charge operation in t1 to t2 in FIG. 5B.

Thereafter, the AD conversion operation of the reset signal in t2 to t4 may be the same as the operation in t2 to t4 in FIG. 5B.

Next, the signal bypass is activated to turn on the switching element SW4 (t5 to t5-1). At this time, the data signal line VSL has a voltage corresponding to the reset signal. The ramp signal line Lrmp has decreased to near the reference voltage (for example, the ground voltage) in the detection of the reset signal. By the switching element SW4 short-circuiting the ramp signal line Lrmp and the data signal line VSL, the voltage of the ramp signal line Lrmp and the voltage of the data signal line VSL are neutralized to be the intermediate voltages thereof. That is, the data signal line VSL is internally pre-charged by the ramp signal line Lrmp.

Next, the signal bypass is inactivated to turn off the switching element SW4, and then the switching element SW3 is turned on to pre-charge the data signal line VSL to the reference voltage (for example, the ground voltage) (t5-1 to t6). The pre-charge operation in t5-1 to t6 may be the same as the pre-charge operation in t5 to t6 in FIG. 5B.

Thereafter, the AD conversion operation of the data signal in t6 to t8 may be the same as the operation in t6 to t8 in FIG. 5B.

The ADC 20 performs AD conversion on the voltage level of the data signal to be output as digital pixel data DPXS to the signal processing section 80.

The other operations of the fifth embodiment may be the same as the operation of the second embodiment.

As in the fifth embodiment, before the pre-charge operation of the data signal line VSL, the switching element SW4 short-circuits the data signal line VSL and the ramp signal line Lrmp, so that the data signal line VSL can be internally pre-charged to some extent. As a result, the amount of charges of the pre-charge from the outside (alternatively, the amount of charges to be discharged to the outside) can be reduced. This leads to a reduction in current consumption of the ramp generator 220.

### Sixth Embodiment

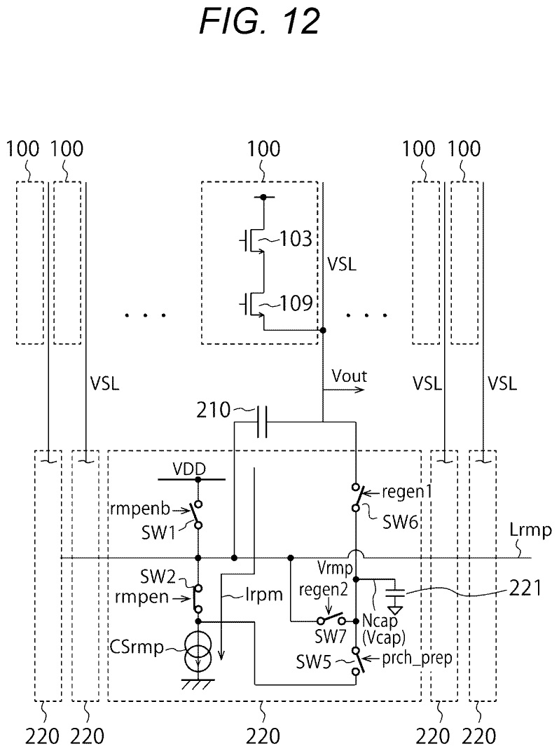

FIG. 12 is a diagram illustrating a configuration example of the ramp generator 220 according to a sixth embodiment. The ramp generator 220 further includes switching elements SW5 to SW7 and a capacitive element 221. The other configurations of the sixth embodiment may be similar to the corresponding configurations of the first embodiment.

One end of the capacitive element 221 is connected to a node Ncap, and the other end thereof is connected to a reference voltage source (for example, ground).

The switching element SW5 is connected between the node Ncap at one end of the capacitive element 221 and the current source CSrmp. The switching element SW5 is controlled to be turned on or off by a signal prch prep.

The switching element SW6 is connected between the data signal line VSL and the node Ncap. The switching element SW6 is controlled to be turned on or off by a signal regen1.

The switching element SW7 is connected between the ramp signal line Lrmp and the node Ncap. The switching element SW7 is controlled to be turned on or off by a signal regen2. The switching elements SW5 to SW7 include n-type MOSFETs, for example. The signals prch prep, regen1, and regen2 are controlled by the controller 15.

In the pre-charge operation, the capacitive element 221 charges (lowers) the data signal line VSL to the reference voltage via the capacitive element 210. Furthermore, in the detection operation of the pixel signal, the capacitive element 221 transmits the rise of the ramp signal line Lrmp to the data signal line VSL via the capacitive element 210 to support the rise of the voltage of the data signal line VSL. That is, the capacitive element 221 supports fluctuation of the voltage of the data signal line VSL in the pre-charge operation and the detection operation of the pixel signal by using capacitive coupling between the ramp signal line Lrmp and the data signal line VSL via the capacitive element 210. As a result, the current consumption of the ramp generator 220 can be further reduced.

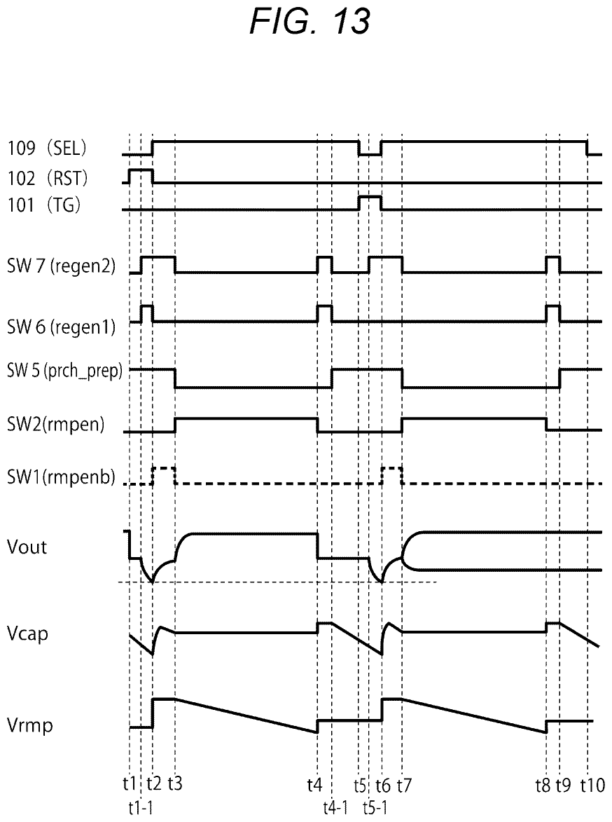

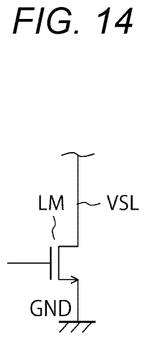

FIG. 13 is a timing diagram illustrating an operation example of the ramp generator 220 according to the sixth embodiment.

The operation of the sixth embodiment is different from the operation of the first embodiment in the pre-charge operation. Until immediately before driving the ramp signal Vrmp (to t3), the switching elements SW6 and SW7 are in an off state, and the switching element SW5 is in an on state. As a result, a current is extracted from one end (node Ncap) of the capacitive element 221 by the constant current source CSrmp. Therefore, in t1 to t2, the voltage Vcap of the node Ncap decreases substantially linearly.

Here, at t1-1, the switching elements SW6 and SW7 are turned on. As a result, the node Ncap is connected to the data signal line VSL, and the voltage Vout of the data signal line VSL decreases (pre-charged) similarly to the voltage Vcap of the node Ncap.

Next, at t2, the switching element SW6 is turned off while the switching elements SW5 and SW7 remain on. Moreover, the switching element SW1 is turned on. As a result, the node Ncap is separated from the data signal line VSL and capacitively coupled to the data signal line VSL via the capacitive element 210. The node Ncap and the ramp signal line Lrmp are charged by the power supply voltage VDD via the switching element SW1. Therefore, the voltages Vcap and Vrmp increase. The voltage Vout of the data signal line VSL capacitively coupled to the node Ncap also increases as the voltages Vout and Vrmp increase.

At t3, the detection operation of the pixel signal is started by turning off the switching elements SW5 and SW7, and turning off the switching element SW2. That is, the linear change of the ramp signal Vrmp is started. At this time, since the node Ncap is separated from the ramp signal line Lrmp, the capacitive element 210, and the data signal line VSL, the node Ncap does not affect the detection operation of the pixel signal. Therefore, the detection operation of the pixel signals in t3 to t4 is similar to that of the first embodiment.

At t4, the switching element SW2 is turned off, and the AD conversion operation of the reset signal is terminated. At the same time, by turning on the switching elements SW6 and SW7, the node Ncap is connected to the data signal line VSL and the ramp signal line Lrmp. As a result, the charges of the data signal line VSL flow to the node Ncap and the ramp signal line Lrmp, and the capacitive element 221 and the ramp signal line Lrmp are charged. At this time, the capacitive element 221 and the ramp signal line Lrmp do not receive charge supply from the outside, and are internally charged using the charges of the data signal line VSL. This leads to a reduction in current consumption.

Next, at t4-1, the switching elements SW6 and SW7 are turned off, and the switching element SW5 is turned on. As a result, charges are extracted from the node Ncap at one end of the capacitive element 221 by the current source CSrmp, and the voltage of the voltage Vcap of the node Ncap decreases substantially linearly.

Here, at t5-1, the switching element SW7 is turned on. As a result, the node Ncap is connected to the ramp signal line Lrmp and capacitively coupled to the data signal line VSL via the capacitive element 221. As a result, in t5-1 to t6, the voltage Vout of the data signal line VSL decreases (pre-charged) similarly to the voltage Vcap of the node Ncap.

Next, at t6, the switching element SW1 is further turned on while the switching elements SW5 and SW7 remain on. As a result, the node Ncap and the ramp signal line Lrmp are charged by the power supply voltage VDD via the switching element SW1. Therefore, the voltages Vcap and Vrmp increase. The voltage Vout of the data signal line VSL capacitively coupled to the node Ncap also increases as the voltages Vout and Vrmp increase.

At t7, the detection operation of the pixel signal is started by turning off the switching elements SW5 and SW7, and turning on the switching element SW2. That is, the linear change of the ramp signal Vrmp is started. At this time, since the node Ncap is separated from the ramp signal line Lrmp, the capacitive element 210, and the data signal line VSL, the node Ncap does not affect the detection operation of the pixel signal. Therefore, the AD conversion operation of the data signals in t7 to t8 is similar to that of the first embodiment.

The ADC 20 performs AD conversion on the voltage level of the data signal to be output as digital pixel data DPXS to the signal processing section 80.

At t8, the switching element SW2 is turned off, and the AD conversion operation of the reset signal is terminated. At the same time, by turning on the switching elements SW6 and SW7, the node Ncap is connected to the data signal line VSL and the ramp signal line Lrmp. As a result, the charges of the data signal line VSL flow to the node Ncap and the ramp signal line Lrmp, and the capacitive element 221 and the ramp signal line Lrmp are charged. At this time, the capacitive element 221 and the ramp signal line Lrmp do not receive charge supply from the outside, and are internally charged using the charges of the data signal line VSL. This leads to a reduction in current consumption.

At t9, the current is extracted from the node Ncap at one end of the capacitive element 221 by the constant current source CSrmp by turning off the switching elements SW6 and SW7, and turning on the switching element SW5. Therefore, after t9, the voltage Vcap of the node Ncap decreases substantially linearly.

Thereafter, the process returns to t1, and the pre-charge operation of the next pixel signal is started.

According to the sixth embodiment, in t4 to t4-1, the data signal line VSL, the node Ncap at one end of the capacitive element 221, and the ramp signal line Lrmp are short-circuited. As a result, the capacitive element 221 and the ramp signal line Lrmp can be internally charged using the charge of the data signal line VSL after the detection of the pixel signal. Since the voltage Vrmp of the ramp signal line Lrmp can be pre-charged to some extent without using an external current, this leads to a reduction in current consumption.

Furthermore, in t5 to t6, the voltage Vcap of the node Ncap is substantially linearly decreased by the constant current source CSrmp, and the data signal line VSL is decreased (pre-charged) by capacitive coupling via the capacitive element 210. The voltage Vcap of the node Ncap can internally pre-charge the voltage Vrmp of the ramp signal line Lrmp, leading to a reduction in current consumption.

Furthermore, in t6 to t7, the node Ncap and the ramp signal line Lrmp are charged by the power supply voltage VDD via the switching element SW1. The voltage Vout of the data signal line VSL capacitively coupled to the node Ncap also increases as the voltages Vcap and Vrmp increase. As a result, it is possible to support that the voltage Vout of the data signal line VSL becomes a voltage according to the pixel signal while suppressing the current consumption. Furthermore, since the voltage Vout of the data signal line VSL capacitively coupled to the node Ncap increases due to capacitive coupling with the node Ncap, a transient increase in the voltage Vout can be suppressed.

Moreover, since the voltage Vcap of the node Ncap is lowered by the constant current source CSrmp via the switching element SW5 in t1 to t2, t4-1 to t6, and at t9 and after to, a constant current flows from the capacitive element 221 to the reference voltage source, but a large current does not flow. This also leads to a reduction in current consumption.

A plurality of embodiments selected from the first to fourth embodiments can be combined.

### Modifications

FIG. 14 is a diagram illustrating a modification of the second to fourth embodiments. In the present modification, instead of the capacitive element 210 and the ramp generator 220, a current source LM is directly connected to the data signal line VSL, and a constant current flows through the data signal line VSL. The current source LM is connected between the data signal line VSL and the ground GND as a reference voltage source. The gate voltage of the current source LM is controlled by the controller 15, and is set such that the current source LM causes a constant current to flow. In the present modification, the capacitive element 210 and the ramp generator 220 are not provided. The other configuration of the present modification may be the same as the configuration of any of the second to fourth embodiments. As described above, the present modification can be applied to any one of the second to fourth embodiments.

### Application Example to Mobile Body

The technology according to the present disclosure (present technology) can be applied to various products. For example, the technology according to the present disclosure may also be implemented as a device mounted on any type of mobile body such as an automobile, an electric vehicle, a hybrid electric vehicle, a motorcycle, a bicycle, a personal mobility, an airplane, a drone, a ship, and a robot.

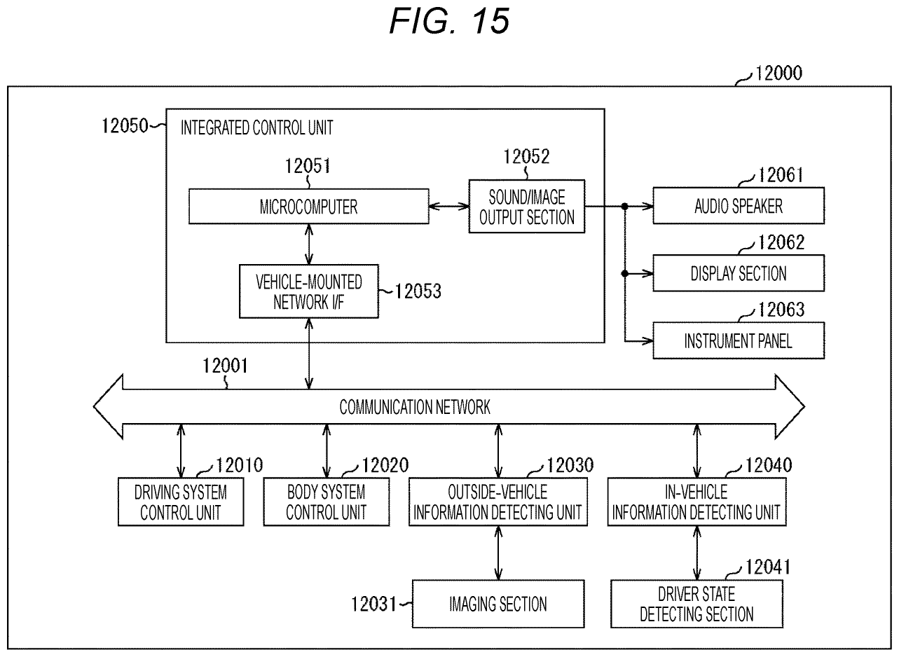

FIG. 15 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example depicted in FIG. 15, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 15, an audio speaker 12061, a display section 12062, and an instrument panel 12063 are illustrated as the output device. The display section 12062 may, for example, include at least one of an on-board display and a head-up display.

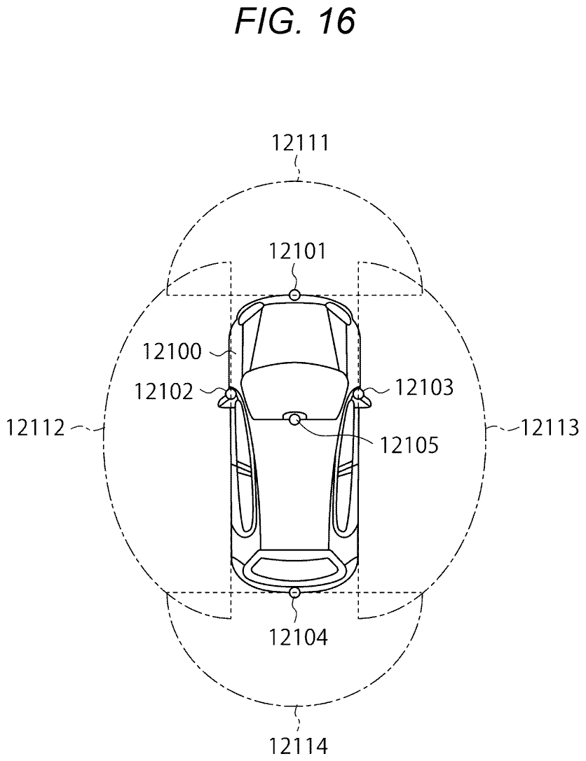

FIG. 16 is a view illustrating an example of the installation position of the imaging section 12031.

In FIG. 16, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 16 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object.

When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like, for example, among the configurations described above.

Note that the present technology can also employ the following configurations.
(1)

An Imaging Device Including:
a pixel section that photoelectrically converts incident light to generate a pixel signal, the pixel section including a plurality of pixels;
a first signal line that transmits the pixel signal from the pixel section;
a second signal line that transmits a control signal for causing a current to flow through the first signal line;
a capacitive element connected between the first signal line and the second signal line;
a first switching element connected between the second signal line and a first power supply; and
a second switching element and a current source connected in series between the second signal line and a second power supply.
(2)

The imaging device according to (1), further including a third switching element connected between the second signal line and the second power supply.
(3)

The imaging device according to (1) or (2), in which
a plurality of the first signal lines is provided, and
the capacitive element, the first switching element, the second switching element, and the current source are provided in each of the first signal lines.
(4)

The imaging device according to (1) or (2), in which
the plurality of pixels constitutes a plurality of pixel columns,
the plurality of first signal lines is provided corresponding to the plurality of pixel columns, respectively, and
the second signal line is provided in common for the plurality of pixel columns.
(5)

The imaging device according to (3) or (4), in which the second signal line is provided in common with the plurality of first signal lines.
(6)

The imaging device according to (1) or (2), in which when the second switching element is in a conductive state, the current source causes a current to flow from the capacitive element to change a voltage of the control signal with a first slope.
(7)

The imaging device according to (6), in which after a voltage of the first signal line is set to a voltage corresponding to the pixel signal, the current source changes the voltage of the control signal with the first slope.
(8)

The imaging device according to (1) or (2), in which when the first switching element is in a conductive state, the first power supply charges the second signal line and the capacitive element.
(9)

The imaging device according to (1) or (2), in which when one of the first and second switching elements is in a conductive state, another of the first and second switching elements is in a non-conductive state.
(10)

The imaging device according to (2), in which the third switching element is a P-type metal oxide semiconductor field effect transistor (MOSFET).
(11)

The imaging device according to (10), in which
a first gate voltage is applied to a gate of the third switching element when the pixel signal generated in the pixel in a reset state is output to the first signal line,
a second gate voltage is applied to a gate of the third switching element when the pixel signal generated in the pixel in a state of receiving incident light is output to the first signal line, and
the first gate voltage is higher than the second gate voltage.
(12)

The imaging device according to any one of (1) to (11), in which the plurality of pixels is connected between a third power supply and a fourth power supply, the third power supply having a voltage lower than a voltage of the first power supply, the fourth power supply having a voltage lower than a voltage of the second power supply.
(13)

The imaging device according to (12), in which a voltage difference between the third power supply and the fourth power supply is substantially equal to a voltage difference between the first power supply and the second power supply.
(14)

The imaging device according to any one of (1) to (13), further including:
a reference signal generator that generates a reference signal changing at a second slope;
a comparator that compares the pixel signal from the first signal line with the reference signal; and
a counter that is connected to an output of the comparator and performs counting from change start of the reference signal until the pixel signal and the reference signal intersect, in which
the reference signal generator changes a voltage of the reference signal with the second slope in a direction opposite to a change in a voltage of the pixel signal with respect to a change in intensity of the incident light.
(15)

The imaging device according to (14), in which in a case where the voltage of the pixel signal decreases as the intensity of the incident light becomes larger, the reference signal generator changes the voltage of the reference signal with the second slope from a voltage lower than the voltage of the pixel signal to a voltage higher than the voltage of the pixel signal.
(16)

The imaging device according to (2), further including a fourth switching element connected between the first signal line and the second signal line.
(17)

The imaging device according to (6), in which the fourth switching element is in a conductive state immediately before the third switching element is in a conductive state.
(18)

The imaging device according to (1), further including:
a second capacitive element having one end connected to a first node and another end connected to the second power supply;
a fifth switching element connected between the first node and the current source;
a sixth switching element connected between the first node and the first signal line; and
a seventh switching element connected between the first node and the second signal line.
(19)

The imaging device according to (18), in which at least one of the fifth to seventh switching elements is brought into a conductive state in a pre-charge operation before detection of the pixel signal.

Note that the present disclosure is not limited to the above-described embodiments, and various modifications can be made without departing from the gist of the present disclosure. Furthermore, the effects described in the present description are merely examples and are not limited, and other effects may be provided.

### REFERENCE SIGNS LIST

10 Imaging element
11 Pixel array
12 Row decoder
13 Pixel driver
14 Column signal processing section
15 Controller
80 Signal processing section
90 Imaging device
100 Pixel
101 Transfer transistor
102 Reset transistor
103 Amplification transistor
109 Selection transistor
210 Capacitive element
220 Ramp generator
Lrmp Ramp signal line
SW1 to SW3 Switching element
CSrmp Current source
VSL Data signal line
PD Photodiode

1. An imaging device comprising:
a pixel section that photoelectrically converts incident light to generate a pixel signal, the pixel section including a plurality of pixels;
a first signal line that transmits the pixel signal from the pixel section;
a second signal line that transmits a control signal for causing a current to flow through the first signal line;
a capacitive element connected between the first signal line and the second signal line;
a first switching element connected between the second signal line and a first power supply; and
a second switching element and a current source connected in series between the second signal line and a second power supply.

2. The imaging device according to claim 1, further comprising a third switching element connected between the second signal line and the second power supply.

3. The imaging device according to claim 1, wherein
a plurality of the first signal lines is provided, and
the capacitive element, the first switching element, the second switching element, and the current source are provided in each of the first signal lines.

4. The imaging device according to claim 1, wherein
the plurality of pixels constitutes a plurality of pixel columns,
the plurality of first signal lines is provided corresponding to the plurality of pixel columns, respectively, and
the second signal line is provided in common for the plurality of pixel columns.

5. The imaging device according to claim 3, wherein the second signal line is provided in common with the plurality of first signal lines.

6. The imaging device according to claim 1, wherein when the second switching element is in a conductive state, the current source causes a current to flow from the capacitive element to change a voltage of the control signal with a first slope.

7. The imaging device according to claim 6, wherein after a voltage of the first signal line is set to a voltage corresponding to the pixel signal, the current source changes the voltage of the control signal with the first slope.

8. The imaging device according to claim 1, wherein when the first switching element is in a conductive state, the first power supply charges the second signal line and the capacitive element.

9. The imaging device according to claim 1, wherein when one of the first and second switching elements is in a conductive state, another of the first and second switching elements is in a non-conductive state.

10. The imaging device according to claim 2, wherein the third switching element is a P-type metal oxide semiconductor field effect transistor (MOSFET).

11. The imaging device according to claim 10, wherein
a first gate voltage is applied to a gate of the third switching element when the pixel signal generated in the pixel in a reset state is output to the first signal line,
a second gate voltage is applied to a gate of the third switching element when the pixel signal generated in the pixel in a state of receiving incident light is output to the first signal line, and
the first gate voltage is higher than the second gate voltage.

12. The imaging device according to claim 1, wherein the plurality of pixels is connected between a third power supply and a fourth power supply, the third power supply having a voltage lower than a voltage of the first power supply, the fourth power supply having a voltage lower than a voltage of the second power supply.

13. The imaging device according to claim 12, wherein a voltage difference between the third power supply and the fourth power supply is substantially equal to a voltage difference between the first power supply and the second power supply.

14. The imaging device according to claim 1, further comprising:
a reference signal generator that generates a reference signal changing at a second slope;
a comparator that compares the pixel signal from the first signal line with the reference signal; and
a counter that is connected to an output of the comparator and performs counting from change start of the reference signal until the pixel signal and the reference signal intersect, wherein
the reference signal generator changes a voltage of the reference signal with the second slope in a direction opposite to a change in a voltage of the pixel signal with respect to a change in intensity of the incident light.

15. The imaging device according to claim 14, wherein in a case where the voltage of the pixel signal decreases as the intensity of the incident light becomes larger, the reference signal generator changes the voltage of the reference signal with the second slope from a voltage lower than the voltage of the pixel signal to a voltage higher than the voltage of the pixel signal.

16. The imaging device according to claim 2, further comprising a fourth switching element connected between the first signal line and the second signal line.

17. The imaging device according to claim 6, wherein the fourth switching element is in a conductive state immediately before the third switching element is in a conductive state.

18. The imaging device according to claim 1, further comprising:
a second capacitive element having one end connected to a first node and another end connected to the second power supply;
a fifth switching element connected between the first node and the current source;
a sixth switching element connected between the first node and the first signal line; and
a seventh switching element connected between the first node and the second signal line.

19. The imaging device according to claim 18, wherein at least one of the fifth to seventh switching elements is brought into a conductive state in a pre-charge operation before detection of the pixel signal.
